(19) United States
(12) Patent Application Publication
(10) Pub. No.: US 2012/0125449 A1
(43) Pub. Date: May 24, 2012

(54) EXPANSION VALVE WITH A PLUG AND A FLOW SELECTOR

(75) Inventors: Paul Muzzo, Yutz (FR); Michel Antoine, Arlon (BE); Morgan Lamiable, 1 rue Jean-Marie Pelt (FR)

(73) Assignee: LUXEMBOURG PATENT COMPANY S.A., Lintgen (LU)

(21) Appl. No.: 13/381,045

(22) PCT Filed: Jun. 29, 2010
(86) PCT No.: PCT/EP2010/059221

§ 371 Date: Feb. 7, 2012

(30) Foreign Application Priority Data
Jun. 30, 2009 (LU) 91582

(51) Int. Cl. F16K 29/00

(52) U.S. Cl. 137/333

(57) ABSTRACT

The invention relates to a valve device including a built-in expansion valve and a flow selector. The valve function is provided by a blocker mounted so as to be inverted. The expansion valve is arranged laterally and communicates with a high-pressure chamber immediately downstream from the blocker and with a low-pressure chamber via a side passage. A device for mechanically controlling the blocker is provided in a chamber sealingly separated from the high-pressure chamber and from the low-pressure chamber. A flow selector in the form of a disc with a calibrated opening is provided in the low-pressure chamber, the disc engaging with a passage directly linked to the outlet of the device. The mechanical control device engages with a control pin of the disc.

### CROSS-REFERENCE TO RELATED APPLICATIONS

The present invention is the US national stage under 35 U.S.C. §371 of International Application No. PCT/EP2010/059221, which was filed on Jun. 29, 2010 and which claims the priority of LU application 91582 filed on Jun. 30, 2009 the content of which (text, drawings and claims) is incorporated here by reference.

### FIELD

The invention relates to a valve device for a fluid, more particularly for pressurized gas. The valve device is adapted to be mounted on a bottle for storing pressurized gas. More particularly but in a non-limiting manner, the device is adapted to be mounted on an oxygen bottle for ensuring a controlled service flow of oxygen.

### BACKGROUND

The statements in this section merely provide background information related to the present disclosure and may not constitute prior art.

Various devices adapted to ensure the triple function of shut-off valve, pressure reducer device, and service flow control are known in the state of the art.

Document WO 2008/092906 A1 of the same applicant discloses a valve device with integrated pressure reducer and flow selector adapted, in particular, to the medical field for providing oxygen to patients. This device is particular in that it integrates the pressure reducer to the closing function of the device. Indeed, the pressure reducer is integrated to an item of equipment which is movable in translation and comprises the blocker. The movable item of equipment is actuated in translation by a mechanical device converting the rotational movement of the hand wheel into a translational movement intended to open or close the valve device. The rotary hand wheel is mechanically connected to a disc pierced with several calibrated holes or openings moving in rotation in front of an opening of the body in direct connection with the outlet. Manipulating the hand wheel enables, in the opening direction from a closed position, the dual action of opening the passage of gas and selecting the flow and, in the closing direction, the closing function of the device. Naturally, this design is very interesting from the standpoint of manipulation; however, it comprises several drawbacks. Indeed, this design imposes a certain height of the device because of the arrangement in a superposed manner with respect to the longitudinal axis of the device, starting from the bottom up to the outlet, of the blocker, of the device for maintaining residual pressure, of the pressure reducer, of the mechanical device for controlling the movable item of equipment. This height can be a hindrance to the integration of the device in a cap, in particular for an assembly on smaller size bottles compared to the bottles for industrial use. In addition, the mechanical device for controlling the movable item of equipment is in a low-pressure chamber through which the gas travels from the pressure reducer to the service outlet of the device. This mechanical device comprises an element with a pressure ball acting on the movable item of equipment. This element comprises an outer threading cooperating with an inner threading of the body. It further comprises splines cooperating with corresponding splines of another element connected to the hand wheel. The result of this design is that the manipulation of the hand wheel can trigger particles, e.g., metallic particles, to be released within this chamber and these particles can subsequently be entrained by the gas flow toward the outlet and thus the user. This potential release of particles is particularly undesirable for the use for which the device is intended, namely, the medical field.

### SUMMARY

An object of the invention is to provide a valve device overcoming at least one of the above-mentioned drawbacks.

The invention consists of a valve device for fluid, particularly for pressurized gas comprising: a body with a longitudinal axis, an inlet at a lower portion of said body, an outlet at an upper portion of said body and a passage connecting said inlet with said outlet; a blocker, movable along a direction substantially parallel to said longitudinal axis and cooperating with a stationary seat in said passage so as to be able to close said passage; a rotary member of manual control arranged at the upper portion, preferably at the top, of said body; a device for converting the rotary movement of said control member into a translational movement along said longitudinal axis, said conversion device being connected to said control member and being adapted to displace said blocker in order to open or close said passage as a function of the manipulation of said control member; whereby said conversion device is arranged in an isolated chamber of said passage, preferably vented to the atmosphere, said passage surrounding said chamber.

Such an arrangement makes it possible to avoid the transfer of particles originating from the mechanical frictions of the control device toward the gas provided by the device.

According to an advantageous embodiment of the invention, the outlet is arranged above the chamber of the conversion device along the longitudinal axis.

According to another advantageous embodiment of the invention, the passage comprises a lateral section with respect to the longitudinal axis of the body, said section surrounding the chamber of the conversion device.

According to another advantageous embodiment of the invention, the valve device comprises a pressure reducer device arranged laterally with respect to the longitudinal axis and in connection with the passage, the valve device further comprising a low-pressure chamber arranged around and/or above the chamber of the conversion device, said low-pressure chamber being in connection with the outlet and the pressure reducer device.

According to another advantageous embodiment of the invention, the low-pressure chamber comprises a device for selecting the flow at the outlet, preferably with a disc having calibrated openings, said selection device being mechanically connected to the rotary control member and to the conversion device.

According to another advantageous embodiment of the invention, the conversion device comprises a first piece, generally circular and comprising an outer threading cooperating with a stationary inner threading, said first piece being movable in rotation and in translation via its outer threading, and a second piece, movable only in rotation, ensuring the mechanical connection between the control member and the first piece, the second piece preferably comprising a flange ring, preferably made in one piece with said second piece, provided with calibrated openings adapted to move in front of a passage section in direct connection with the outlet.

According to another advantageous embodiment of the invention, the first movable piece comprises a cavity with which the second movable piece cooperates in rotation.

According to another advantageous embodiment of the invention, the conversion device comprises a third stationary piece having the shape of a bell with an inner threading cooperating with the outer threading of the first piece, said third piece forming, with a cavity of the body, the chamber of the conversion device.

According to another advantageous embodiment of the invention, the second piece cooperates with the first piece inside the third piece by means of splines, parallel to the longitudinal axis, the second piece being mounted sealingly in rotation with respect to said third piece.

According to another advantageous embodiment of the invention, the conversion device is such that the second piece can be inserted in the third piece and in the first piece by insertion from the top of the device when the first and third pieces are set in place on the body.

According to another advantageous embodiment of the invention, the blocker and the seat are arranged in such a manner that a movement of said blocker in the sense of the flow from said inlet toward said outlet closes the passage and vice-versa, and that the conversion device is adapted to come in free contact with said blocker so as to open the passage.

According to another advantageous embodiment, a clearance is present between the conversion device and the blocker when the control member is in closed position.

According to another advantageous embodiment of the invention, the blocker or the seat is equipped with sealing means, and said blocker comprises a mechanical abutment so as to limit the deformation of the sealing means when said blocker is in the closed position and subjected to the pressure of the fluid.

According to another advantageous embodiment of the invention, the mechanical abutment of the blocker comprises a circular element surrounding the sealing means of the blocker.

Further areas of applicability of the present teachings will become apparent from the description provided herein. It should be understood that the description and specific examples are intended for purposes of illustration only and are not intended to limit the scope of the present teachings.

### DRAWINGS

Other characteristics and advantages of the present invention will be better understood from the description and the drawings.

FIG. 1 is a cross-sectional view of the valve device according to the invention.

FIG. 2 is a hydraulic diagram of the device of FIG. 1.

### DETAILED DESCRIPTION

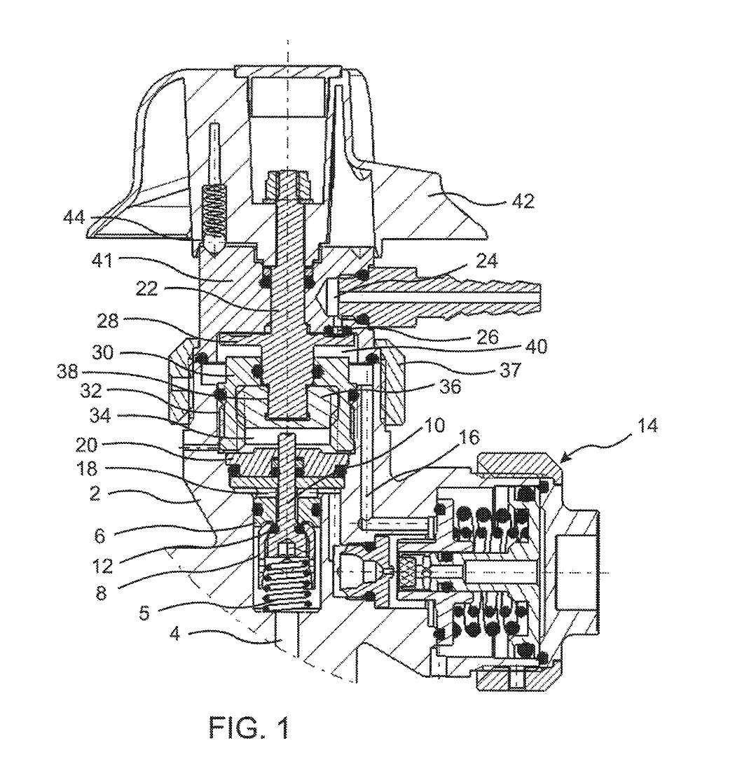

The valve device of FIG. 1 comprises a body 2 having a longitudinal axis corresponding to a vertical axis such as shown in the drawing. The representation of the lower portion of the body is truncated for clarity purposes. However, it is to be noted that additional specific functions of the lower portion of such a device, such as, for example, a filter function, a function for indicating the bottle pressure or even a filler connector function, can absolutely be envisioned.

The body 2 of the valve device comprises an inlet (not shown), typically in the form of a threaded male end part adapted to be screwed on a bottle. This inlet is in connection with a passage 4 formed in the body 2. The passage 4 comprises, at the lower portion of the body, a first cavity comprising a device for blocking the passage. This blocking device comprises a blocker 10, a seat 6, and a spring 5. The seat 6 is of the metallic type and attached to the body 2. It has an annular surface whose section has a hollow or even a bowl, and a raised portion in the vicinity of the opening of the passage of the gas. The blocker 10 is symmetrical in rotation with respect to its longitudinal axis which is coaxial with the longitudinal axis of the device. The blocker 10 comprises a flared or conical portion comprising a groove in which an O-ring 12 is housed. This flared or conical portion ends toward the bottom by a threaded cylindrical portion. A skirt 8 having a corresponding shape and dimension is screwed on this cylindrical portion of the blocker. This skirt 8 surrounds the O-ring 12 and comes into contact with the O-ring 12. The skirt 8 has, at the approximate level of the O-ring 12, an added thickness of material at its top in a direction, parallel to the longitudinal axis of the blocker 10. This added thickness of material forms an annular surface adapted to come into contact with the bottom of the groove of the seat during substantial closing forces on the blocker 10. Indeed, in the closing position, the blocker 10 is subjected to the pressure of the gas in the bottle. When this pressure reaches a value corresponding to a maximum with an added safety margin, for example a value on the order of 240 bars, the force resulting from this pressure distorts the O-ring 12 supported on the seat 6 to such a level that the upper surface of the skirt 8 also becomes supported on the seat 6. This metal-metal support limits the travel of the blocker 10 and makes it possible to prevent the O-ring 12 from deteriorating, which, otherwise, would result in a variation of the closed position of the blocker 10.

The skirt 8 also serves to guide or maintain the spring 5. The lower end of the blocker 10 comprises a cavity having a polygonal section, for example corresponding to six sides, adapted to receive a tool for tightening the skirt 8 on the blocker 10 before assembling the device.

The blocker 10 comprises a portion, cylindrical or in the form of a rod, cooperating with means for sealing a separator 20 of the high-pressure chamber 18. The seat 6 is indeed housed in a bore provided in the body 2. The seat 6 is subsequently covered with the separator 20 provided with joints adapted to provide leaktightness with the body 2 as well as with the rod of the blocker 10.

The high-pressure chamber 18 communicates via a passage formed by a first boring with a laterally arranged pressure reducer 14. The details of the pressure reducer 14 are not extensively described insofar as the pressure reducer 14 is designed conventionally as known to one having ordinary skill in the art. Briefly, a moving armature comprises a pellet cooperating sealingly with a stationary seat on the body 2. This moving armature comprises a passage for the gas supplying a chamber delimited by the most lateral portion of the moving armature and by the chamber of the body in which the moving armature is housed. The pressure on this surface of the moving armature can move this moving armature toward the seat so as to more or less close the passage of gas.

A second boring 16 is provided in the body, communicating the outlet of the pressure reducer directly with the low-pressure chamber 40. This passage 16 surrounds a chamber 34 containing the control mechanism of the blocker 10. This chamber 34 is indeed delimited by the bell-shaped piece 30 rigidly fixed to the body 2 of the device by a threaded connection 32. A joint is also provided between the outer surface of the piece 30 and the corresponding inner surface of the body 2 so as to make the chamber 34 leaktight with respect to the low-pressure chamber 40.

The piece 30 further comprises an inner threading cooperating with the outer threading of the piece 36. This piece 36 has a generally cylindrical shape having an inner contact surface with the rod of the blocker 10 as well as a hollow at its upper surface adapted to cooperate in rotation with a control pin 22. The cavity of the piece 36 comprises splines (not shown in the drawing) parallel to the longitudinal axis of the device and the outer surface of the lower end of the control pin 22 comprises corresponding splines. These splines ensure a rotational connection while allowing for a displacement of the piece 36 with respect to the control pin 22 along the longitudinal axis.

The bell-shaped piece 30 comprises an opening at its center as well as an O-ring housed in a groove formed in the opening. This opening accommodates the pin 22 in the area of a more substantial section than that of its end comprising the splines cooperating with the movable piece 36. The chamber 34 is thus sealingly separated from the low-pressure chamber 40 by the upper portion of the bell-shaped piece 30 and the joints associated to this piece cooperating with the body 2 and the pin 22. The chamber 34 is also sealingly separated from the high-pressure chamber 18 by the separator 20 and the associated joints cooperating with the body 2 and the rod of the blocker 10. This chamber 34 is vented to the atmosphere via a boring made laterally in the body 2.

The low-pressure chamber 40 is delimited by the body 2, the upper surface of the bell-shaped piece 30 and the pin support 41. This pin support 41 constitutes the upper portion of the body of the valve device which is attached to the body 2 per se by means of a locking mounting ring 37. A joint is provided in the area of the support surface of the support of the pin 22 which comes into contact with the body 2 in order to ensure a leaktightness of the low-pressure chamber 40.

The control pin 22 is supported and guided by the support 41. It comprises a disc 28 made in one piece with the pin 22, the disc 28 having a series of calibrated holes or openings distributed over a diameter corresponding to that of a passage 26 communicating the low-pressure chamber 40 with an outlet 24. A joint is provided in a counterbore in the area of the passage 26 in order to ensure a leaktightness with the surface of the disc 28. The disc 28 takes support on the corresponding surface of the support 41.

The upper portion of the control pin 22 is connected to a hand wheel 42. The section of the portion of the pin 22 cooperating with the hand wheel 42 is non-circular, so as to provide a rotational connection of the pin and the hand wheel 42. The hand wheel 42 comprises a ball system 44 cooperating with one or several hollows provided on the upper surface of the support 41 for indexing purposes. A joint and an anti-extrusion ring are provided between the circular portion of the control pin 22 and the support 41 so as to ensure a leaktightness with respect to the outside of the low-pressure chamber 40. A splined end-piece is screwed at the outlet 24 of the device in order to receive a service tube.

During assembly, the blocking device 5, 6, 8, 10, is first set in place in the body 2 from the top of said body. The lid 20 is then arranged on top of the blocking device 5, 6, 8, 10 and the bell-shaped piece 30 with the movable piece 36 are screwed inside the bell-shaped piece 30 is then screwed in the body 2. The annular lower surface of the bell-shaped piece 30 then becomes to be supported on the lid 20 and maintains the entire blocker portion in place in the body 2. A working pressure, typically 240 bars, is thus applied at the inlet of the device so as to simulate a maximum work situation. In this case, the blocker 10 is in a metal-metal support, that is, in abutment against the seat 6 via the skirt 8. The position of the blocker thus corresponds to a maximum high closing position. The movable piece 36 is subsequently manually actuated in rotation via the upper opening of the bell-shaped piece 30 so the lower surface of the movable piece 36 is flush with the upper surface of the blocker rod. The pin support 41 equipped with the control pin 22, the hand wheel 42, and its locking mounting ring 37 is subsequently set in place by a translational movement from the top downward so that the splined end-piece of the control pin 22 penetrates inside the splined cavity of the movable piece 36. The hand wheel 42 must be in the OFF position corresponding to the closing of the device. This way, the mechanical control device of the blocker 10 is correctly indexed with the hand wheel 42 which is itself indexed with the disc 28 having calibrated openings via the indexing pin in the area of the pin-hand wheel connection.

In operation, the hand wheel has a first OFF indexed position described hereinabove whereby the movable piece 36 is at a distance, even very short, from the upper surface of the rod of the blocker 10. The system for blocking the high pressure is thus closed and the chamber, so-called high-pressure chamber 18, is not supplied with high pressure.

The hand wheel 42 has a second ON/0 indexed position at a distance from the first position, conventionally on the order of a quarter to a half turn. In this position, the control pin 22 has carried out a corresponding rotation which has resulted in making the movable piece 36, and therefore the blocker 10, go down. The device for blocking the gas is thus open and the high-pressure chamber 18 has the same pressure as the bottle. The pressure reducer 14 is pressurized and closed, and operational. In the ON/0 position, the disc 28 has a surface closed to the passage 26, which means that the device delivers no gas toward the outlet.

The hand wheel 42 then presents a series of indexed positions corresponding to various flow values, such as, for example, 1-1.5-2-3-4-5-6-9-12-15 given, for example, in liters/minute. To each of these indexed positions corresponds a calibrated opening of the disc 28.

This device thus allows for a simplified manipulation for the user by means of the single hand wheel 42.

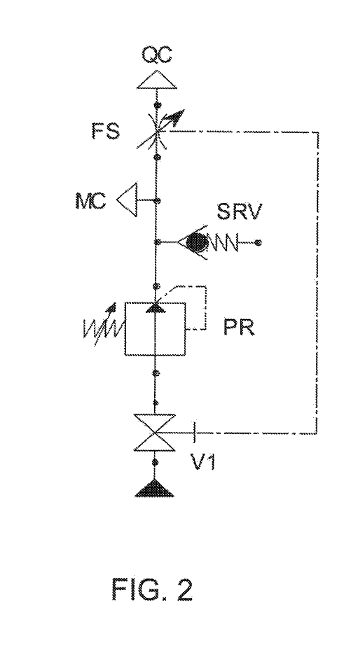

FIG. 2 shows the hydraulic diagram of the device of FIG. 1. Starting from the inlet toward the outlet, it shows a valve V1 corresponding to the blocking device 6, 10; a pressure reducer PR corresponding to the pressure reducer 14; a safety release valve, not shown in FIG. 1 since it is located at the rear of the device; an outlet referred to as medical MC (medical connector), also not shown and in direct connection with the low-pressure chamber 40 and a flow selector FS corresponding to the disc 28 having calibrated openings cooperating with the passage 26. The dotted line connecting the flow selector FS to the valve V1 corresponds to the mechanical connection between the control pin 22 of the flow selector and the blocker 10.

1.-14. (canceled)

15. A valve device for fluid, particularly for pressurized gas comprising:
a body with a longitudinal axis, an inlet at a lower portion of said body, an outlet at an upper portion of said body and a passage connecting said inlet with said outlet;
a blocker movable along a direction substantially parallel to said longitudinal axis and cooperating with a stationary seat in said passage so as to be able to close said passage;
a manually controlled rotary control member arranged at an upper portion, preferably at the top, of said body;
a conversion device for converting the rotary movement of said control member into a translational movement along said longitudinal axis, said conversion device being connected to said control member and being adapted to displace said blocker in order to open or close said passage as a function of the manipulation of said control member, wherein said conversion device is arranged in an isolated chamber of said passage, preferably vented to the atmosphere, said passage surrounding said chamber.

16. The valve device according to claim 15, wherein the outlet is arranged above the chamber of the conversion device along the longitudinal axis.

17. The valve device according to claim 15, wherein the passage comprises a lateral section with respect to the longitudinal axis of the body, said lateral section surrounding the chamber of the conversion device.

18. The valve device according to claim 15 further comprising:
a pressure reducer device arranged laterally with respect to the longitudinal axis and in connection with the passage: and
a low-pressure chamber arranged around and/or above the chamber of the conversion device, said low-pressure chamber being in connection with the outlet and the pressure reducer device.

19. The valve device according to claim 18, wherein the low-pressure chamber comprises a selection device for selecting the flow at the outlet, including a disc having calibrated openings, said selection device being mechanically connected to the rotary control member and to the conversion device.

20. The valve device according to claim 15, wherein the conversion device comprises:
a first piece, generally circular and comprising an outer threading cooperative with a stationary inner threading of a bell-shaped piece of the valve device, said first piece being movable in rotation and in translation via its outer threading, and
a second piece, movable only in rotation, ensuring the mechanical connection between the control member and the first piece, the second piece comprising a flange ring provided with calibrated openings adapted to move in front of a passage section of the valve device in direct connection with the outlet.

21. The valve device according to claim 20, wherein the first piece comprises a cavity with which the second piece cooperates in rotation.

22. The valve device according to claim 21, wherein the conversion device further comprises a stationary third piece having the shape of a bell with an inner threading cooperating with the outer threading of the first piece, said third piece forming, with a cavity of the body, the chamber of the conversion device.

23. The valve device according to claim 22, wherein the second piece cooperates with the first piece inside the third piece by means of splines, parallel to the longitudinal axis, the second piece being mounted sealingly in rotation with respect to said third piece.

24. The valve device according to claim 23, wherein the conversion device is structure such that the second piece can be inserted in the third piece and in the first piece by insertion from the top of the valve device when the first and third pieces are set in place on the body.

25. The valve device according to claim 15, wherein the blocker and the seat are arranged in such a manner that a movement of said blocker in the sense of the flow from the inlet toward the outlet closes the passage and vice-versa, and that the conversion device is adapted to come in free contact with said blocker so as to open the passage.

26. The valve device according to claim 25 further comprising a clearance disposed between the conversion device and the blocker when the control member is in a closed position.

27. The valve device according to claim 26, wherein the blocker or the seat is equipped with sealing means, and said blocker comprises a mechanical abutment so as to limit deformation of the sealing means when said blocker is in the closed position and subjected to pressure of a fluid.

28. The valve device according claim 27, wherein the mechanical abutment of the blocker comprises a circular element surrounding the sealing means of the blocker.
